(19) United States
(12) Patent Application Publication
(10) Pub. No.: US 2008/0319843 A1
(43) Pub. Date: Dec. 25, 2008

(54) SUPPLY OF REQUESTED OFFER BASED ON POINT-OF-SERVICE TO OFFEREE DISTANCE

(76) Inventors: Dennis Norman Moser, Atherton, CA (US); Jay A. DeWitt, Spokane, WA (US)

Correspondence Address: Quarles & Brady LLP, TWO NORTH CENTRAL AVENUE, One Renaissance Square, PHOENIX, AZ, 85004-2391, US

(21) Appl. No.: 11/767,218

(22) Filed: Jun. 22, 2007

(51) Int. Cl. G06Q 30/00; G06F 17/30

(52) U.S. Cl. 705/14

(57) ABSTRACT

An automated communication system supplies a requested offer for inventory to an offeree based on the distance between an offeror-merchant to the offeree. A consumer can request an in-person offer for inventory using a consumer device that transmits to a Requested Offer Supplier (ROS) the request, the location of the consumer device to a Requested Offer Supplier (ROS), and a return address. The ROS matches the consumer's request for inventory to a set of merchants having the requested inventory, and that are willing to make an in-person offer for the requested inventory. The ROS transmits the in-person offer to the consumer with the consumer device. The customer may then travel to the offering merchant and enter into a transaction with the merchant for the requested inventory that applies the in-person offer to the transaction.

### BACKGROUND

Merchants deliver offers to consumers through various venues. One example widely used today is the newspaper coupon. Manufacturers and retailers also distribute coupons to potential customers as part of their sales promotions, such as through the mail, magazines, newspapers, and more recently, through printable versions of the coupon available on the Internet.

Another example of a merchant offer is one presented through a loyalty program. Loyalty programs provide customers with incentives to shop at certain loyalty program participating facilities or to show loyalty to a particular merchant or service provider, such as a financial institution. In addition to receiving discounts or financial awards, an incentive may include redeemable goods or services. Success of a loyalty program can be measured by how well it targets users that will participate in the program in order to receive the incentives described and provided as part of the loyalty program.

Current merchant offers have a number of drawbacks. Typically, there is a significant time delay between the merchant offer and the consumer purchase. For example, the paper coupon must be printed and delivered to a customer. Moreover, the customer should remember to have the coupon in hand when making an eligible purchase in order to gain the benefit of the offer presented in the coupon. Similarly, in a loyalty program, points are often accumulated over time in order to redeem an incentive associated with the loyalty program.

Another drawback of current merchant offers is that the merchant offer is typically driven by the merchant—not the consumer. Coupons and loyalty programs often reflect the merchant's prophetic estimation on what its customer base may be interested in buying at a particular purchase price or points that its customer base may be willing to pay.

It would be an advance in the art to provide a merchant offer that lessens the foregoing drawbacks.

### SUMMARY

In one implementation, a requested offer is supplied based on the relative distance between a point-of-service to the offeree customer.

In another implementation, an automated communication system has a call handler that sends and receives transmissions to a consumer device used to transmit a request for inventory—such as a good or service. The call handler is in communication with a computer having storage for information and code. The storage has information about a plurality of merchants, such as each merchant's name, location, and inventory. When the code is executed, the computer receives the requested inventory from the call handler and the location of the consumer device. The computer forms a first set of matching merchants that have respective inventories matching the requested inventory, and forms a second set of matching merchants as a function of a distance between the location of the consumer device and each of the merchants it has information on. The computer also forms a third set of matching merchants that are both in the first and second sets and offering an in-person offer applicable toward a transaction involving the requested inventory. A transmission to the consumer device is formed by the computer that includes the third set of matching merchants, their respective locations, and their respective in-person offers.

In yet another implementation, a method is provided to include receiving a consumer device transmission having a request for inventory and the location of a consumer device, forming a first set of matching merchants that have respective inventories matching the requested inventory, forming a second set of matching merchants as a function of a distance between the location of the consumer device and that of each of the merchants, forming a third set of matching merchants that are both in the first set and the second set and offering an in-person offer for the requested inventory, and forming a consumer device transmission including the third set of matching merchants, their respective locations, and their respective in-person offers.

The value of the in-person offer may be derived using a distance of a merchant's point-of-service relative to the consumer, that consumer's transaction history, or a combination thereof. As such, the offeree consumer is likely to receive an in-person offer for inventory that the consumer is interested in taking advantage of because the in-person offer has been specifically tailored by the offeror to an attribute of the consumer offeree—such as the present location or past shopping behavior of the offeree consumer.

Implementations provide for a consumer to request a special offer for a specific good or service, or a category thereof, which offer can be used by the consumer to consummate a purchase of the good and service from the offeror thereof. Implementations inherently open new opportunities for merchants to move inventory while also rewarding consumers with personalized offers.

### BRIEF DESCRIPTION OF THE DRAWINGS

Implementations of the invention will become more apparent from the detailed description set forth below when taken in conjunction with the drawings, in which like elements bear like reference numerals.

FIG. 1 is a block diagram illustrating an exemplary system for supplying a requested offer;

FIG. 2 is a flow chart illustrating an exemplary processes through which a requested can be supplying in the environment of the system illustrated in FIG. 1; and

FIG. 3 is a block level diagram illustrating an exemplary payment processing system which can be used by an offeree executing a transaction for an offer made by an offeror within the environment of the system illustrated in FIG. 1.

### DETAILED DESCRIPTION

Implementations enable a consumer to request an in-person offer for inventory, such as a good or service. To do so, the consumer uses a consumer device that transmits the request, the location of the consumer device, and a return address. The request goes to a Requested Offer Supplier (ROS) that will match the requested inventory to a set of merchants that: (i) are located within a predetermined distance to the consumer device; (ii) have inventory matching the request, and (iii) are willing to make an in-person offer to the consumer that corresponds to the requested inventory. For example, the merchant can provide the consumer, via the ROS, an in-person offer for the inventory based on the distance between the consumer and the merchant, such as 10% off the purchase price of consumer-requested inventory when the consumer is less than 1 mile from the merchant's store.

In response to the consumer making a request for inventory, the ROS transmits the in-person offer to the consumer via the return address. The consumer may then travel to the merchant offering the in-person offer and conduct a transaction for the requested inventory that applies the in-person offer to the transaction. As such, the merchant's volume at a point-of-service increases while the consumer realizes benefit from acting upon the in-person offer.

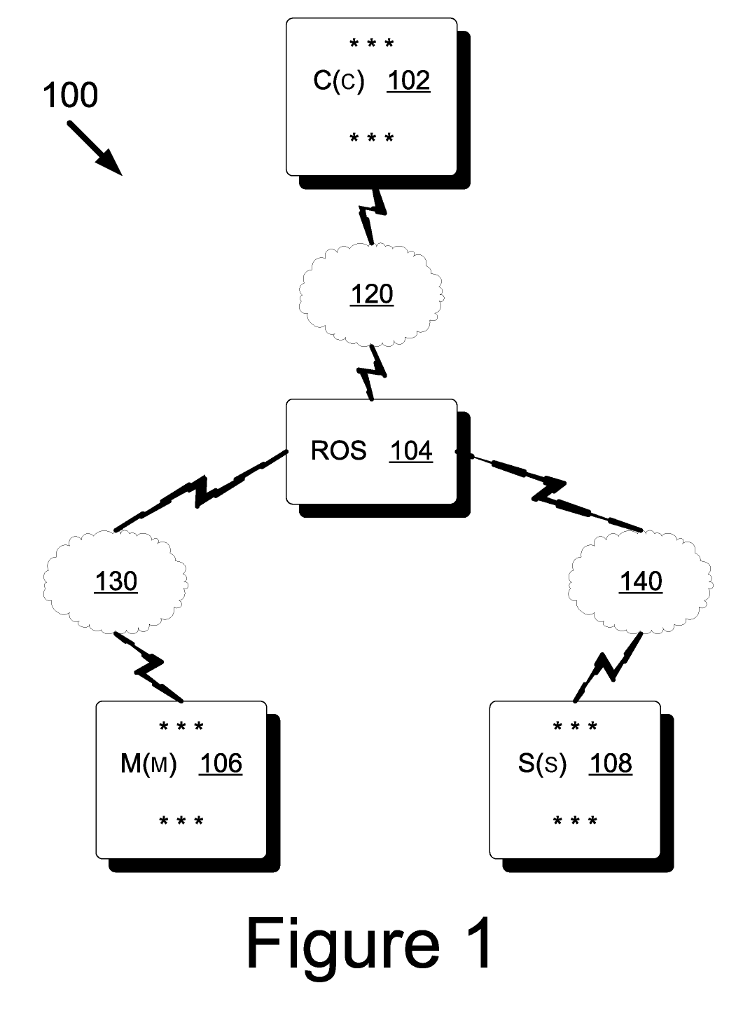

Referring to FIG. 1, an exemplary automated communication system 100 is illustrated for supplying a requested offer based on point-of-service to offeree distance. A consumer, such as a person, a group of persons, or a person representing an entity, may have a consumer device. As seen in FIG. 1, each consumer device is represented by consumer device C(c) 102, where c can be a value from 1 to C. For example, consumer device C(c) 102 can be a cellular phone, a personal digital assistant (PDA), a kiosk located in a retail establishment such as a shopping mall, a pager, or a wireless terminal. Consumer device C(c) 102 transmits a consumer device transmission to the ROS 104 through a C-ROS network 120.

The consumer device transmission may include the request for inventory, such as a good or service, that the consumer may be interested in purchasing, hiring, leasing, licensing, or gaining the benefit of. The requested inventory may be a description of a good or service, such as “blue high heel shoes”; the make and/or model of a good or service such as Apple iPod Nano® music player; a category for a good or service such as “Barber”; a unique inventory identifier such as Stock Keeping Unit (SKU), a Universal Product Code (UPC), or International Standard Book Number (ISBN); a description of a manufacturer such as “mp3 player manufacturer”; a description of the function of a good or service such as “equipment for painting a house”; or an optically scanned image associated with the requested inventory such as a picture of a book or an infrared scan of: a SKU, an ISBN, a UPC, or bar code.

Moreover, the consumer device transmission may include a unique identifier of the consumer, such as an account number associated with the automated communication system, account number associated with a payment processing system such as system for processing a credit card purchase relative to a credit card company, a social security number, a consumer name, a consumer code, or a combination thereof.

Moreover, the first transmission may include a return address or a code associated with the return address. The return address may be the location of the consumer, the address of the consumer device C(c) 102, or the address of a different consumer device C(c−1) 102. For example, the consumer device C(c) 102 may be a PDA that is used to form a transmission having a phone number to a wireless telephone as the return address. Return addresses may include, for example: a cellular telephone number/address, an Internet Protocol (IP) address, a street address, an email address. The code associated with the return address may be a password, an identification code, a code associated with the account in the payment processing system such as an account number, a routing number, or combinations thereof.

The consumer device transmission may include the location of the consumer. The location of the consumer can be a future location that the consumer believes the consumer will be at, at a predetermined date and time. Alternatively, the location can be the real time location of the consumer based on, for example, the real time location (e.g.; present location) of the consumer device C(c) 102. Consumer device C(c) 102 may have or be in communication with a position detecting system, such as global positioning system, that can determine the real time location of the consumer device C(c) 102 including the street address of consumer device C(c) 102, the latitude and longitude of the consumer device C(c) 102, the World Geodetic System coordinates of consumer device C(c) 102, or combinations thereof. By way of example from the foregoing, the transmission from consumer device C(c) 102 through the C-ROS network 120 may include the requested inventory, the unique consumer identifier, and the return address that may be the real time location of consumer device C(c) 102.

The transmission from consumer device C(c) 102 may take different forms. The transmission may, for example, be a Short Message Service (SMS) transmission, a voice transmission, or a data transmission such as a data transmission over the Internet. For example, consumer device C(c) 102 may have an Internet browser that can connect to a server associated with the ROS 104. The consumer may have to enter a user identification and password to access an account with the ROS 104. The account may be specific to consumer device C(c) 102 such that access is limited solely through use of consumer device C(c) 102, or access may be specific to the consumer such that the consumer may access the account through a plurality of consumer devices consumer device C(c through C) 102.

Once the account is accessed, the consumer may enter text in a query box, choose from a pull down menu having inventory categories, enter a voice recording describing the request for inventory, pick through hyperlinked web pages describing inventory of the merchant M (m through M) 106, or choose from thumbnail pictures of the merchant M (m through M) 106s' inventory. As seen in FIG. 1, each merchant is represented by a reference numeral merchant M(m) 106, where m can have a value from 1 through M. Other contemplated forms of data entry by use of consumer device C(c) 102 are well known in the art. In some implementations, a consumer may have to download software to the consumer device C(c) 102 to enable the above described transmissions and formations thereof.

The ROS 104 may have an automatic call handler configured to receive and send transmissions, such as to consumer device C(c) 102, and a server linked to a storage system through a network ROS-S 140. Here, the storage system is represented in FIG. 1 at reference numeral storage S(s) 108, where the value of s can be from 1 to S. As such, each storage S(s) 108 can be one or more storage devices which may each include data, such as information about a plurality of merchants (1 through M) 106. For example, the data may include a name for each merchant M(m) 106, a location for merchant M(m) 106, a location for inventory that is available to merchant M(m) 106, a location of each of a plurality of a competitors of each merchant M(m) 106, a list the goods and/or services in the inventory of each merchant M(m) 106, or a combination thereof.

The data stored at storage S(s) 108 may also include information regarding the consumer. For example, storage S(s) 108 may include: the inventory requested by a consumer using consumer device C(c) 102, the return address for the consumer, the code associated with the return address, the location of consumer device C(c) 102, the unique identifier for the consumer corresponding to consumer device C(c) 102, the home address of the consumer, a previous consumer device C(c) 102 location, a previous request for inventory from the consumer corresponding to consumer device C(c) 102, a previous transaction that the consumer corresponding the consumer device C(c) 102 may have been a party to, a previous transaction to which the consumer corresponding to the consumer device C(c) 102 applied an in-person offer, or a combination thereof. Storage S (s) 108 can be a database, such as a relational database, that is located within the ROS 104.

Alternatively, each storage S(s) 108 can be in a different geographic location such that S(1) 108 is at a different geographical location than storage (S) 108.

Each storage S(s) 108 may be associated with computer code that, when executed, can match the requested inventory received from consumer device C(c) 102 with a set of merchants (1 through m) 106 who are willing to make at least one in-person offer from their respective inventories that corresponds to the inventory that was requested by the consumer.

The ROS 104 may also be in communication with the plurality of merchants (1 through M) 106 through an ROS-M network 130. For example, the ROS 104 may transmit a merchant transmission to merchant M(m) 106 via the ROS-M network 130, where the merchant transmission will includes information from storage S(s) 108 such as the requested inventory from the consumer with consumer device C(c) 102, the consumer unique identifier, information corresponding to an account in the payment processing system such as purchases made on the account that match the requested inventory, the location of consumer device C(c) 102, the return address, or a combination thereof. Merchant M(m) 106 may transmit a merchant transmission to the ROS 104. For example, merchant M(m) 106 may transmit to the ROS 104 a list of its inventory via ROS-M network 130. Alternatively, merchant M(m) 106 may send a confirmation transmission to the ROS 108 that a transaction occurred at the merchant M(m) 106 location that applied the merchant M(m) 106 in-person offer.

Merchant M(m) 106 inventory includes in stock inventory or inventory that can be obtained within a predetermined time period. Merchant M(m) 106 may be a retail store that has inventory at the merchant M(m) 106 location when merchant M(m) 106 offers the in-person offer. Alternatively, merchant M(m) 106 may have a warehouse that is at a different location from the merchant M(m) 106 retail store or merchant M(m) 106 may be a franchisee with access to inventory located at other franchisee stores. The inventory may be a new item that has not yet arrived into the market, or the inventory may be a service such an oil change for an automobile, a house cleaning service, or a mobile service such as a taxi cab service.

Merchant M(m) 106 may offer an in-person offer for the consumer requested inventory with the condition that the inventory will be available to the consumer within a window of time such that the in-person offer is irrevocable within that window of time. For example, an in-person offer may expire three (3) hours after the consumer receives the in-person offer via that consumer's corresponding consumer device C(c) 102 over C-ROS network 120. The start time for the window need not begin with the receipt of the in-person offer by consumer device C(c) 102. For example, a consumer may request a Microsoft® Xbox® gaming platform prior to it entering the market. Merchant M(m) 106 may know that it has a shipment of Microsoft® Xbox® products coming in two (2) weeks. Merchant M(m) 106 may make an in-person offer with the condition that the inventory will be available to the consumer at a time period between 2 weeks to 3 weeks from the date of the consumer device transmission that makes the requested for the X-Box® product inventory. In another example, merchant M(m) 106 may be a restaurant. The consumer may request service for a particular date. The merchant can make the in-person offer valid for a time period on the requested date such as Dec. 24, 2007 from 4:00 p.m. to 8:00 p.m.

Merchant M(m) 106 may make an in-person offer to the offeree consumer using the consumer device C(c) 102 based on a distance between the location of consumer device C(c) 102 and that of the inventory of merchant M(m) 106. The in-person offer may be valid for a transaction that physically occurs at the location of merchant M(m) 106. For example, if the consumer device C(c) 102 is within 5 miles of the inventory, merchant M(m) 106 may offer a two-for-one in-person offer, while if consumer device C(c) 102 is within five minutes walking distance from the inventory, merchant M(m) 106 may offer a 15% off in-person offer. Therefore, merchant M(m) 106 may tailor the in-person offer to the offeree's initial request for the inventory. The tailoring can be based on the merchant M(m) 106 assessment of what kind of in-person offer may be best to entice the particular consumer to make the effort to travel the distance to the point of service and to conduct a transaction involving the request inventory, such as purchasing the requested good or received the requested service.

Merchant M(m) 106 may update data in S(s) 108 with information regarding the inventory of merchant M(m) 106. For example, merchant M(m) 106 may have an account with the ROS 104. Merchant M(m) 106 may log on to its account using a web service application and update its inventory list in S(s) 108 at predetermined time periods such as every week. In another example, merchant M(m) 106 may have part of S(s) 108 in communication with an inventory maintenance system of merchant M(m) 106, such as an accounting system for merchant M(m) 106 that may update automatically the data in S(s) 108.

Merchant M(m) 106 may be associated with a merchant processing system. The merchant processing system may be an in-house computer that communicates with the ROS 104 via the ROS-M network 130. For example, a franchisor may manage each merchant M(m) 106 that are within the franchisor's franchisees. The franchisor, as the merchant processing system, may be in communication with the ROS 104. When the franchisor receives a processing system transmission including the consumer requested inventory, it determines the location of matching inventory and either has the merchant M(m) 106 franchisee make the in-person offer or the franchisor may make the in-person offer directly to the ROS 104 that the ROS 104 then communicates to the consumer's consumer device C(c) 102 via the a transmission to the return address. Alternatively, the merchant processing system may be a third party with a contractual arrangement with merchant M(m) 106, linking the ROS 104 with merchant M(m) 106. For example, the merchant processing system may be part of a mall management that overlooks leasing, marketing, maintenance of common area, security of common area and operational activities with each merchant M(m) 106, the customers of each merchant M(m) 106, or the suppliers of each merchant M(m) 106. The mall management may receive a processing system transmission including information such as the requested inventory, a indication of the transaction history of purchases made on the account in the payment processing system, a return address, an indication of the location of consumer device C(c) 102 transmitting the first consumer device transmission such as the consumer device C(c) 102's proximate location within the mall, a location of a competitor location, a location of a home address of a consumer associated with consumer device C(c) 102, or a combination thereof. The mall management may then send to the ROS 104 a second processing system transmission including a set of matching merchants, that is a plurality of merchant M(m) 106, offering an in-person offer for the requested inventory and their respective in-person offers.

In yet another example, the merchant processing system may be a dispatching unit for taxi cab drivers. The consumer may use consumer device C(c) 102 to submit a request for a taxi ride service for departure to a destination. The merchant processing system may locate a taxi closest to consumer device C(c) 102, give an offer for the ride from the location of consumer device C(c) 102 to the destination, and dispatch the closest taxi upon receiving a return processing system transmission that the consumer accepts the in-person offer. In another example, the merchant processing system may locate a taxi service the that the consumer with the account has used in the past and transmit the taxi service's offer via a merchant processing system transmission.

In order to be part of the system 100, the entities will preferably first enroll into the system 100. For example, the consumer may first have to enroll by opening an ROS account with the ROS 104. The ROS account may be specific to the consumer device C(c) 102 corresponding to the consumer, in which access the ROS account is limited to uses of the consumer device C(c) 102, or it may be consumer specific through the use of a consumer unique identifier. The consumer may set up a profile within the ROS account. For example, the consumer may enter information regarding the consumer's home address into storage S(s) 108 and request that consumer device C(c) 102 receive any in-person offers for a new release of specific DVDs that are sold near the consumer's home address.

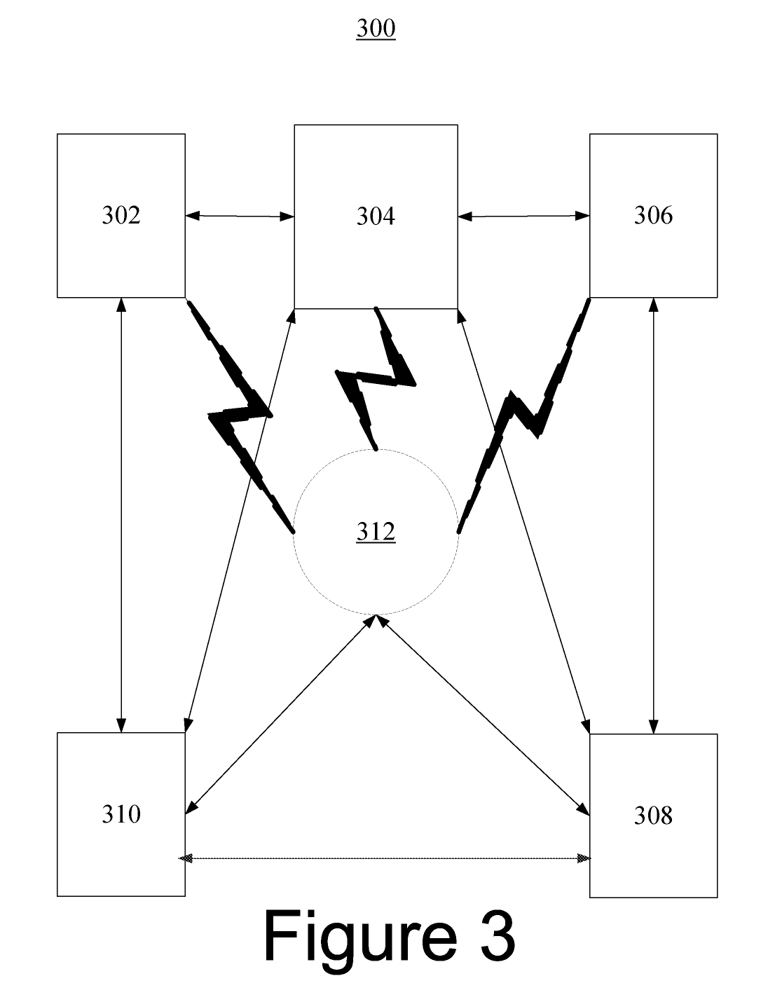

The consumer may also enter the consumer's credit card information into the ROS account. For example, the consumer may enter credit card information for the consumer's gold card corresponding to a particular payment processing system as described below relative to FIG. 3. Merchant M(m) 106 may give different in-person offers to gold card members that merchant M(m) 106 would not otherwise offer—such as 10% off luxury items including non-costume jewelry.

Each merchant M(m) 106 may also enroll in order to be part of the system 100, and will involve itself in setting up a corresponding merchant profile. For example, merchant M(m) 106 may set up a merchant profile indicating the location of each of merchant M(m) 106's franchisees and their respective inventories. Merchant M(m) 106 may give the ROS 104 business rules that can be executed by the code in storage S(s) 108 such that in-person offers can be algorithmically calculated without having to contact personnel at any merchant M(m) 106 location for each consumer requested inventory.

The business rules may also denote conditions around an offer. For example, the ROS 104 may set and transmit conditions around an offer to the merchant M(m) 106 indicating that offers must require the use of a particular brand of credit card. Alternatively, or in combination, the merchant M(m) 106 may require that the consumer utilize a particular brand of credit card when redeeming the merchant's merchant M(m) 106 offer.

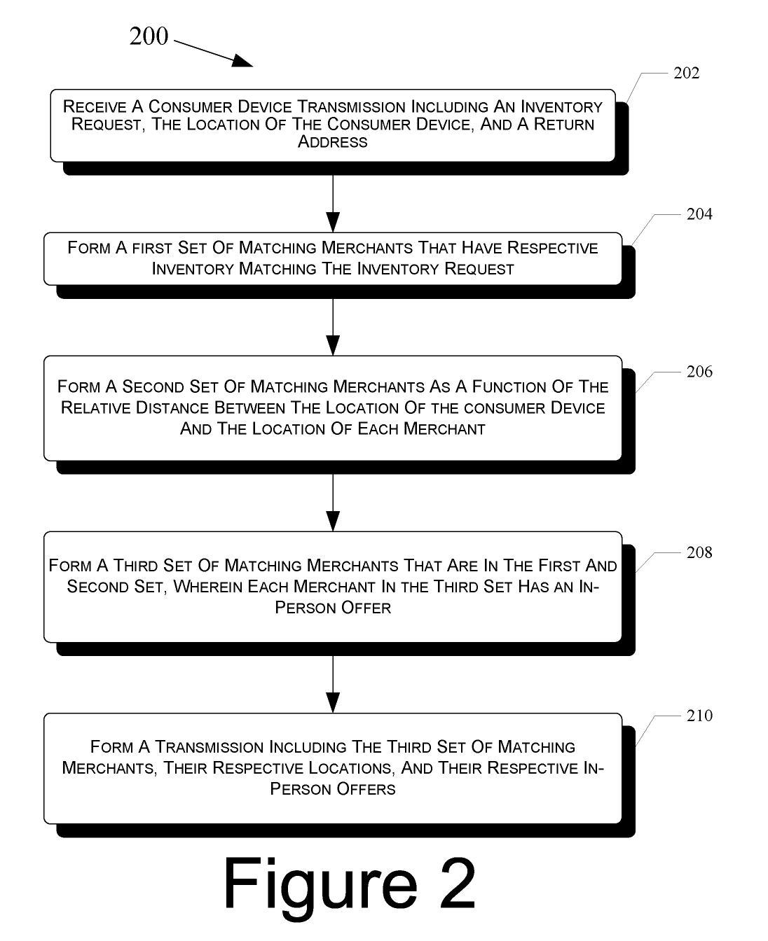

Referring to FIG. 2, a flow chart is used to illustrate an exemplary process 200 for supplying an offer incident to a consumer request for inventory, where the offer is a function of distance. Process 200 begins at step 202 where consumer device C(c) 102 forms a transmission that includes the request for inventory and the location of consumer device C(c) 102, and the return address. For example, a consumer may request a book by its title using a PDA connected to the ROS 104. The PDA may have a GPS that also transmits the location of the PDA to the ROS 104. The transmission may have a unique code for the PDA that the ROS 104 can use to send a transmission back to the PDA. Moreover, the ROS 104 may use the unique code for the PDA to determine the account in the payment processing system. For example, the storage S(s) 108 may have information on the account associated with the unique code for the PDA. Once the ROS 104 receives the unique code for the PDA, it may retrieve the account information. In this manner, the unique code for the PDA can serve two purposes: the return address and the information corresponding to the account in the payment processing system.

At step 204, a first set of matching merchants merchant M(m) 106 is formed using the storage S(s) 108 to signify that they have the consumer requested inventory. Storage S(s) 108 may have a first database in communication with the ROS 104 from which the first set of matching merchants merchant M(m) 106 is formed. Matching consumer requested inventory to merchants merchant M(m) 106 may be done in a number of ways. For example, the merchant M(m) 106 may register certain keywords to be used in matching, such as “hardware” or “chain saw” or “Black and Decker®.” In another example, the merchant M(m) 106 may have a categorization code registered with the server, such as a Merchant Category Code, Standard Industrial Classification (SIC) Code, or IRS Business Activity Code. In another example, the merchant's merchant M(m) 106 address may be registered and utilized in conjunction with other registered or known merchant M(m) 106 attributes or keywords in order to determine merchant's merchant M(m) 106 eligibility to be considered as an offeror.

The matching process may occur through a series of inventory category matches. For example, merchant M(m) 106 may have inventory that is classified according to a predetermined inventory classification system into inventory categories such as apparel, hardware, or home furnishing. The classification system may have sub-categories such as women's comfort shoes, CRAFTSMAN® 3/16×4 in. screwdrivers, or inner spring mattresses. The requested inventory received via the first consumer device transmission may be put into at least one inventory category according to the predetermined inventory classification system. The matching of the requested inventory to each merchant M(m) 106's inventory can occur such as by identifying those merchant M(m) 106 that have inventory in at least one inventory category that the requested inventory is classified into. For example, the consumer may request “blue high heeled shoes” that can be classified into each of the following categories: shoes, women's shoes, blue shoes, and Salvatore Ferragamo® shoes. These categories may have the subclass of “high heel.”Therefore, the category, including the subclasses thereof, for the requested inventory is compared against the category of merchant M(m) 106's inventory until each match is found. As matches are found, the first set of matching merchants merchant M(m) 106 is accumulated and formed. Other methods of matching are well known in the art and are contemplated for implementations with the present invention.

The set of merchants (m) 106s' respective offers may include a inventory list that matches the received requested inventory. For example, if the requested inventory is for bedding, the merchants (m) 106s' offer may include a list of offers for bedding, matching curtains, matching towels, and bedroom furniture.

The ROS 104 may query the consumer device C(c) 102 through successive transmissions until the correct categories are obtained in order to perform a match. consumer device C(c) 102 may have an interface such that requested inventory can be entered using a series of categories from the predetermined classification system, for instance by use of consumer device C(c) 102 having a user interface with an interactive pull down menu showing a branching of the classification system and from which a request for inventory is made by a consumer.

At step 206, a second set of matching merchant M(m) 106 is formed from merchant M(1 through M) 106 as a function of a distance (“first distance”) between the location of consumer device C(c) 102 and that of each merchant M(m) 106. The function may have a predetermined threshold distance value, such as a straight line value or travel time value, such that the relative distance to merchant M(m) 106's location should be below a particular value in order to be in the second set of matching merchants. S(s) 108 may have a second database in communication with the ROS 104 from which the second set of matching merchant M(m) 106 is formed. The second database may comprise of the first set of matching merchant M(m) 106 found in step 204.

At step 208, a third set of matching merchants is formed. The third set are those that are both in the first set and the second set and also are making an in-person offer for a good or service corresponding to the requested inventory. For example, S(s) 108 may have a third database in communication with the ROS 104 from which is formed the third set of matching merchant M(m) 106. The third set may be comprised of the second set of matching merchant M(m) 106 found in step 206.

The ROS 104 may send a merchant transmission to merchant M(m) 106 in order to determine if merchant M(m) 106 is making an in-person offer, or the ROS 108 may have a predetermined algorithmic rule to calculate an in-person offer for merchant M(m) 106. The ROS 108 may then accumulate all matched merchants that are making in-person offers so as to form the third set of matching merchant M(m) 106.

The in-person offer may be derived from a second distance, the past transaction history of the consumer, or a combination thereof. The second distance may be equal to the distance between the location of the consumer device C(c) 102 and that of merchant M(m) 106 (the first distance) or a distance between consumer device C(c) 102 and competitors of each merchant M(m) 106. For example, Nieman Marcus may offer 10% off shoes to the customer making a request for shoes via consumer device C(c) 102 in a transmission that indicates that consumer device C(c) 102 is located not more than five (5) minutes walking distance from a Nieman Marcus® retail store, and Nieman Marcus may additionally offer 15% off shoes to the customer making a request for shoes via consumer device C(c) 102 in a transmission that indicates that consumer device C(c) 102 is located not more than five (5) minutes walking distance from its competitor, a Saks Fifth Avenue® retail store.

The in-person offer may be derived from the transaction history of the consumer using consumer device C(c) 102. S(s) 108 may contain the past transaction history of the consumer that the ROS 104 may either relay to merchant M(m) 106, or the ROS 104 may analyze the transaction history of the consumer corresponding to the requesting consumer device C(c) 102 to determine trends and buying habits of the consumer. For example, the consumer may have asked for blue shoes in a consumer device transmission including at least one offer from consumer device C(c) 102 sent to the ROS 104 in the past. Storage S(s) 108 contains logged information of the consumer device transmissions to and from the ROS 104 such as in a transmission database. The ROS 104 may also track the consumer's consumer device transmissions or transactions applying an in-person offer to which the consumer may have been a party in the past. The ROS 104 may use the tracked transmissions and/or transactions to rate the consumer's propensity to ask for in-person offers or to apply in-person offers that the ROS 108 may relay to merchant M(m) 106 for merchant M(m) 106's use in deriving the value of an in-person offer.

The value of the in-person offer may be derived using information about the consumer's transaction history independent of whether the consumer had in past made application to obtain an in-person offer for those past transactions in the consumer's transaction history. For example, storage S(s) 108 may include information obtained from the payment processing system on the consumer's transaction history, such as usage of a credit card, that can be mined and analyzed. For instance, the consumer may use a particular payment card, such as a credit card, to make seasonal purchases such as boots that are bought with the credit card every winter. In the subsequent winter, when the consumer requests winter boots through a consumer device transmission using consumer device C(c) 102, the ROS 104 can utilize the payment processing system's information pertaining to the consumer's transaction history regarding winter boots to rate the consumer's propensity to purchase winter boots this year and forward that transaction history to one or more merchant M(m) 106 for use in deriving the value of the in-person offer. Therefore, a Neiman Marcus® retailer may make an in-person offer of five percent (5%) off the regular retail price for boots to the consumer that has no history of purchasing boots in the winter while making an in-person offer of ten percent (10%) off boots to the consumer whose transaction history shows that the consumer typically buys boots every winter. The relative distance between each respective merchant M(m) 106 and consumer device C(c) 102 transmitting the request for boots may be factored in as well, such as giving another five percent (5%) off if the consumer makes it into the Neiman Marcus® retailer within two (2) hours of the sending of the consumer device transmission from consumer device C(c) 102. Other methodologies for deriving the value of the in-person offer based on a combinations of distances and consumer transaction histories are also contemplated.

At step 210, a transmission, such as a second consumer device transmission, addressed to the return address is formed. The transmission may have the third set of matching merchants, their respective locations, and their respective in-person offers. The return address may be to the consumer device C(c) 102 having an interface wherein the names of the third set of matching merchants is presented, each name linking to respective merchant's (m) location or in-person offer.

The transmission to the return address may also have a narrative conveying information about the requested item or the inventory of the third set of matching merchants. For example, the consumer may have requested an in-person offer for a child car seat. The second consumer device transmission may include the third set of matching merchants having in-person offers for the child car seat and include the consumer report® rating for each child car seat listed in the third set of matching merchants. Other examples of narratives include: other consumers' ratings of the requested inventory obtained from a plurality of consumer device C(c) 102, recent news articles about the inventory being requested, alternative inventory that can be requested such as suggested related inventory for use with the requested item of inventory (e.g.; a suggestion of socks appropriate for consumer requested shoes), and advertisements such as promotional materials for “red shoes” when the requested inventory was “blue shoes.”

The steps 202-210 can occur over a short period of time. The first consumer device transmission and the second consumer device transmission may occur consecutively over a period of seconds to minutes, such as about 5 minutes, thus approaching a typical impulse purchase decision time period corresponding to the type of inventory being requested by a consumer.

The merchant M(m) 106 in-person offer from merchant M(m) 106 may have a corresponding offer-confirmation code. The offer-confirmation code may be an alphanumeric code, a word, a character, a symbol, a picture, a text and figure combination, an encrypted message, or a combination thereof. The offer-confirmation code may be included in the transmission addressed to the return address, to the merchant transmission addressed to merchant M(m) 106, or to a combination thereof. When the consumer wishes to apply the in-person offer for a transaction at merchant M(m) 106's location, the consumer may present the offer-confirmation code to merchant M(m) 106. The presentation can occur visually, such as when the consumer displays the offer-confirmation code received by consumer device C(c) 102 to merchant M(m) 106 (e.g.; a cellular telephone text message is shown to the merchant's operator of an Acceptance Point Device or Point-Of-Service terminal); verbally such as when the consumer states an alphanumeric sequence or the word representing the offer-confirmation code; or electronically such the consumer entering the offer-confirmation code into a Point of Service (POS) terminal at merchant M(m) 106's location. Merchant M(m) 106 may have a copy of the offer-confirmation code that has been received via the merchant transmission or otherwise via access to storage S(s) 108 or via the ROS 104 so as to validate the consumer's offer-confirmation code that the consumer presents to merchant M(m) 106. For example, merchant M(m) 106 may visually check an alphanumeric code against an alphanumeric code that merchant M(m) 106 has received from the ROS 104 for the in-person offer addressing the inventory requested by the consumer.

The merchant may transmit a confirmation transmission to the ROS 104 including data that confirms that the offer-confirmation code included in the transmission addressed to the return address was matched with the offer-confirmation code included in the merchant transmission. For example, the confirmation transmission may include the matched offer-confirmation code, the location of merchant M(m) 106 where the offer-confirmation code was matched, an indication that the matched offer-confirmation code corresponds to a transaction for the corresponding in-person offer, a date on which the transaction took place, a sub-total of a financial transaction involving only the consumer requested inventory, or the total amount of a financial transaction by a consumer with merchant M(m) 106 which included other items besides the consumer requested inventory.

The ROS 104 may be a transaction handler within the payment processing system associated with the account, such as a credit card company that validates the offer-confirmation code. The transaction handler may have transmitted the offer-confirmation code to the merchant M(m) 106 and to the consumer. After the transaction involving the offer-confirmation code has occurred between the merchant M(m) 106 and the consumer. The merchant M(m) 106's transaction message to transaction handler for the transaction involving the offer-confirmation code may include the offer-confirmation code. The transaction handler may validate the offer-confirmation code within the payment processing system such as by checking the offer-confirmation code sent to the consumer against the received transaction message from merchant M(m) 106. For example, the consumer may use a credit card recognized in a payment processing system to purchase a diamond ring while applying the in-person offer the consumer received for the diamond ring from merchant M(m) 106 via the transaction handler. Merchant M(m) 106's POS terminal may transmit a transaction message to the transaction handler which is the ROS 104 in communication with the payment processing system. The transaction message may include payment information, the value of the in-person offer, and the offer-confirmation code. The transaction handler can then validate the offer-confirmation code during an authentication phase, for example, of the transaction by checking the offer-confirmation code received from the merchant M(m) 106 against what was sent to the consumer. If the offer-confirmation is not matched, the transaction is rejected and the purchase cannot be made using the in-person offer that the consumer presented to merchant M(m) 106.

The ROS 104 may assess fees to the consumer corresponding to consumer device C(c) 102, merchant M(m) 106, or a combination thereof. For example, the ROS 104 may assess fees for enrolling entities that become part of the system 100 such as the consumer or the merchant M(m) 106. The ROS 104 may also assess fees for each transmission sent to or received from C-ROS network 120 or ROS-M network 130, or for other transmissions to third parties using other networks. For example, the ROS 104 may assess fees for transmissions between the ROS 104 and the merchant processing system. The ROS may also assess fees for transactions to which an in-person offer has been applied, such as five cents ($0.05 US) per transaction per entity involved in the transaction.

By way of example, and not by way of limitation, an exemplary suitable payment processing system is illustrated in FIG. 3 and described below.

Referring to FIG. 3, in general, a transaction includes participation from different entities that are a component of a payment processing system 300 including an issuer 302, a transaction handler 304, such as a credit card company, an acquirer 306, a merchant 308 such as merchant M(m) 106, or a user 310 such as an account holder or the consumer. The acquirer 306 and the issuer 302 can communicate through the transaction handler 304. Merchant 308 may be a person or entity that sells goods or services, such as been described about with reference to merchant M(m) 106. Merchant 308 include, for instance, a manufacturer, a distributor, a retailer, a load agent, a drugstore, a grocery store, a gas station, a hardware store, a supermarket, a boutique, a restaurant, or a doctor's office. In a business-to-business setting, the user 310 may be a second merchant making a purchase from another merchant 308. Merchant 308 may utilize at least one POS terminal that can communicate with the acquirer 306, the transaction handler 304, or the issuer 302. Thus, the POS terminal is in operative communication with the payment processing system 300.

Typically, a transaction begins with the user 310, such as an account holder or a consumer, presenting a portable consumer device 312, such as the consumer device C(c) 102, to merchant 308 to initiate an exchange for a good or service. The portable consumer device 312 may include a payment card, a gift card, a smartcard, a smart media, a payroll card, a health care card, a wrist band, a machine readable medium containing account information, a keychain device such as a SPEEDPASS® device commercially available from ExxonMobil Corporation or a supermarket discount card, a cellular phone, personal digital assistant, a pager, a security card, an access card, a wireless terminal, or a transponder. The portable consumer device 312 may include a volatile or non-volatile memory to store information such as the account number or an account holder's name.

Merchant 308 may use the POS terminal to obtain account information, such as an account number, from the portable consumer device 312. The portable consumer device 312 may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer 302 of the portable consumer device 312. Alternatively, or in combination, the portable consumer device 312 may communicate with the issuer 302, the transaction handler 304, or the acquirer 306.

The issuer 302 may authorize the transaction using the transaction handler 304. The transaction handler 304 may also clear the transaction. Authorization includes the issuer 302, or the transaction handler 304 on behalf of the issuer 302, authorizing the transaction in connection with the issuer 302's instructions such as through the use of business rules. The business rules could include instructions or guidelines from the transaction handler 304, the user 310, merchant 308, the acquirer 306, the issuer 302, a financial institution, or combinations thereof. The transaction handler 304 may maintain a log or history of authorized transactions. Once approved, merchant 308 will record the authorization, allowing the user 310 to receive the good or service.

Merchant 308 may, at discrete periods, such as the end of the day, submit a list of authorized transactions to the acquirer 306 or other components of the payment processing system 300. The transaction handler 304 may compare the submitted authorized transaction list with its own log of authorized transactions. If a match is found, the transaction handler 304 may route authorization transaction amount requests from the corresponding acquirer 306 to the corresponding issuer 302 involved in each transaction. Once the acquirer 306 receives the payment of the authorized transaction amount from the issuer 302, it can forward the payment to merchant 308 less any transaction costs, such as fees. If the transaction involves a debit or pre-paid card, the acquirer 306 may choose not to wait for the initial payment prior to paying the merchant 308.

There may be intermittent steps in the foregoing process, some of which may occur simultaneously. For example, the acquirer 306 can initiate the clearing and settling process, which can result in payment to the acquirer 306 for the amount of the transaction. The acquirer 306 may request from the transaction handler 304 that the transaction be cleared and settled. Clearing includes the exchange of financial information between the issuer 302 and the acquirer 306 and settlement includes the exchange of funds. The transaction handler 304 can provide services in connection with settlement of the transaction. The settlement of a transaction includes depositing an amount of the transaction settlement from a settlement house, such as a settlement bank, which the transaction handler 304 typically chooses, into a clearinghouse, such as a clearing bank, that the acquirer 306 typically chooses. The issuer 302 deposits the same from a clearinghouse, such as a clearing bank, which the issuer 302 typically chooses into the settlement house. Thus, a typical transaction involves various entities to request, authorize, and fulfill processing the transaction.

Various terms may be used herein, which are to be understood according to the following descriptions:

1. Acceptance point device includes a device capable of communicating with the portable consumer device 312 including a Point of Service (POS) device, a cellular phone, personal digital assistant (PDA), a pager, a transponder, personal computer (PC), tablet PC, handheld specialized reader, set-top box, electronic cash register (ECR), automated teller machine (ATM), virtual cash register (VCR), kiosk, security system, or access system;

2. Account holder or user includes any person or entity with an account and/or a token;

3. Issuer includes any entity that issues one or more accounts and/or tokens;

4. Merchant includes any entity that supports an acceptance point device;

5. Participant includes any user, person, entity, charitable organization, machine, hardware, software, merchant or business who accesses and uses the system of the invention, such as any consumer (such as primary member and supplementary member of an aggregate consumer account), retailer, manufacturer, and third-party provider, and any subset, group or combination thereof;

6. Redemption includes obtaining a reward using any portion of points, coupons, cash, foreign currency, gift, negotiable instruments, or securities;

7. Reward includes any discount, credit, good, service, package, event, experience (such as wine tasting, dining, travel), or any other item; and

8. Portable consumer device includes a card, smartcard, ordinary credit or debit cards (with a magnetic strip and without a microprocessor), a keychain device (such as the SPEEDPASS® device commercially available from Exxon-Mobil Corporation), cellular phone, personal digital assistant (PDA), pager, payment card, security card, access card, smart media, or transponder, where each token can include a loyalty module with a computer chip with dedicated hardware, software, embedded software, or any combination thereof that is used to perform actions associated with a loyalty program.

The steps of a method, process, or algorithm described in connection with the implementations disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving, at an automated communication system, a first consumer device transmission including:
a request for inventory;
the location of a consumer device transmitting the first consumer device transmission; and
a return address;
forming, from a first database in communication with the automated communication system, a first set of matching merchants from a first plurality of merchants that have respective inventories matching the requested inventory;
forming, from a second database in communication with the automated communication system, a second set of matching merchants from a second plurality of merchants as a function of a first distance between the location of the consumer device and that of each said merchant in the second plurality thereof;
forming, from a third database in communication with the automated communication system, a third set of matching merchants that are both in the first set and the second set and offering an in-person offer for a good or service corresponding to the requested inventory, wherein the in-person offer is derived using a second distance;
and
forming, at the automated communication system, a transmission addressed to the return address and including the third set of matching merchants, their respective locations, and their respective in-person offers.

2. The method as defined in claim 1, further comprising sending the transmission addressed to the return address within about five minutes from the receiving of the first consumer device transmission.

3. The method as defined in claim 1, wherein the first set of matching merchants is identified by:
classifying the received requested inventory, according to a predetermined inventory classification system, into at least one inventory category; and
identifying those merchants in the first database that have inventory in at least one inventory category.

4. The method as defined in claim 1, wherein:
the received requested inventory is a make and model product identifier; and
the first set of matching merchants are identified by matching the make and model product identifier with those merchants in the first database that have inventory corresponding to the make and model product identifier.

5. The method as defined in claim 1, wherein:
for each said merchant in the second plurality thereof, the first distance computed from the location of the consumer device is less than a predetermined distance; and
the first distance is determined by a calculation selected from the group consisting of:
the straight line distance;
the motorized route distance;
the non-motorized route distance;
a distance which can be covered within in a predetermined time period using a motorized vehicle; and
a distance which can be covered within in a predetermined time period using a non-motorized vehicle; and
a distance which can be covered within in a predetermined time period by walking.

6. The method as defined in claim 1, wherein the second distance is selected from the group consisting of:
the first distance; and
the distance between the consumer device and competitors of each said merchant in the second plurality thereof, respectively.

7. The method as defined in claim 1, wherein:
the first consumer device transmission includes a unique identifier of a consumer; and
the in-person offer is derived by also using the unique identifier of the consumer.

8. The method as defined in claim 7, wherein the consumer is selected from the group consisting of:
a person holding an account in a payment system;
a group of persons;
a group associated with an account in a payment system; and
an identifier for the consumer device.

9. The method as defined in claim 1, wherein each said respective in-person offer further comprises an inventory list from each merchant in the third set of matching merchants that match the received requested inventory.

10. The method as defined in claim 9, wherein the inventory list includes one or more goods and services with corresponding information about each.

11. The method as defined in claim 1, further comprising storing in a transmission database the first consumer device transmission and optionally the transmission addressed to the return address.

12. The method as defined in claim 1, wherein:
the transmission addressed to the return address is addressed to the consumer device;
the transmission addressed to the return address further including an offer-confirmation code corresponding to the respective in-person offer; and
the method further comprising forming, at the automated communication system, a first merchant transmission addressed each said merchant in the third set of matching merchants and including the offer-confirmation code corresponding to the respective in-person offer.

13. The method as defined in claim 12, further comprising receiving a first confirmation transmission including data that confirms that the offer-confirmation code in the transmission addressed to the return address was matched at a location of at least one said merchant in the third set of matching merchants.

14. The method as defined in claim 13, wherein the first confirmation transmission further comprises the location of the corresponding merchant for the transaction, a date on which the transaction took place, and a financial amount of the transaction.

15. The method as defined in claim 13, further comprising accessing a fee for at least one of the first consumer device transmission, the transmission addressed to the return address, the first merchant transmission, and the first confirmation transmission.

16. The method as defined in claim 13, wherein confirmation transmission further comprises data indicating that the matched offer-confirmation code corresponds to a transaction for the corresponding in-person offer at the at least one said merchant in the third set of matching merchants.

17. The method as defined in claim 16, wherein the offer confirmation code is validated through a payment processing system processing the transaction corresponding to the in-person offer at the at least one said merchant in the third set of matching merchants.

18. The method as defined in claim 16, further comprising accessing a fee for the transaction corresponding to the in-person offer at the at least one said merchant in the third set of matching merchants.

19. The method as defined in claim 1, further comprising:
sending, from the automated communication system to a merchant processing system, a first processing system transmission communicating information selected from a group consisting of: the requested inventory, an indication of the location of the consumer device transmitting the first consumer device transmission, a location of the merchant's competitor, a location of a home address of a consumer associated with the consumer device, and a combination thereof; and
receiving, at the automated communication system from the merchant processing system, a second processing system transmission including a subset of the third set of matching merchants that are both in the first set and the second set and offering an in-person offer for the requested inventory and their respective in-person offers, wherein the in-person offer is derived from a second distance.

20. The method as defined in claim 1, further comprising, prior to the receiving, enrolling with the automated communication system a plurality of consumers each corresponding at least one said consumer device and each said merchant in the first and second plurality of merchants.

21. The method as defined in claim 20, further comprising accessing a fee for one or more said enrollments.

22. The method as defined in claim 1, wherein the second database includes the first set of matching merchants and the third database includes the second set of matching merchants.

23. The method as defined in claim 1, wherein the received requested inventory includes an optically scanned image data.

24. The method as defined in claim 23, wherein the optically scanned image data includes at least one of a Universal Product Code, and a Stock Keeping Unit (SKU) number.

25. The method as defined in claim 1, wherein the in-person offer is valid for a transaction that physically occurs only at the location of each said respective merchant in the third set of matching merchants.

26. A computer-readable medium comprising computer readable instructions which, when executed by a processor, performs the method of claim 1.

27. An automated communication system comprising:
means for receiving a first consumer device transmission including:
a request for inventory; and
the location of a consumer device transmitting the first consumer device transmission;
means for forming, from a first database in communication, a first set of matching merchants from a first plurality of merchants that have respective inventories matching the requested inventory;
means for forming, from a second database, a second set of matching merchants from a second plurality of merchants as a function of a first distance between the location of the consumer device and that of each said merchant in the second plurality thereof;
means for forming, from a third database, a third set of matching merchants that are both in the first set and the second set and offering an in-person offer for a good or service corresponding to the requested inventory, wherein the in-person offer is derived using a second distance;
and
means for forming a second consumer device transmission addressed to the consumer device and including the third set of matching merchants, their respective geographic locations, and their respective in-person offers.

28. The automated communication system as defined in claim 27, wherein the in-person offer includes a duration for which the in-person offer is irrevocable.

29. The automated communication system as defined in claim 28, wherein the duration corresponds to a travel time equivalent of the group consisting of the first distance and the second distance.

30. The automated communication system as defined in claim 27, further comprising an offer confirmation code for each said third set of matching merchants, wherein:
the second consumer device transmission to the consumer further includes the offer confirmation code for each said third set of matching merchants; and
the offer confirmation code for each said third set of matching merchants is further transmitted to the respective each said third set of matching merchants.

31. The automated communication system comprising:
a call handler to send and receive consumer device transmissions over a network;
a server in communication with the call handler; and
storage for:
information of a plurality of merchants including:
each merchant name;
each merchant location; AND
each merchant inventory;
code, executable by the server, to:
receive a first said consumer device transmission including:
a request for inventory; and
the location of a consumer device transmitting the first consumer device transmission;
form from the information, a first set of matching merchants from the plurality of merchants that have respective inventories matching the requested inventory;
form, from the information, a second set of matching merchants from the plurality of merchants as a function of a first distance between the location of the consumer device and that of each said merchant in the plurality thereof;
form a third set of matching merchants that are both in the first set and the second set and offering an in-person offer for a good or service corresponding to the requested inventory, wherein the in-person offer is derived using a second distance;
and
form a second consumer device transmission addressed to the consumer device and including the third set of matching merchants, their respective locations, and their respective in-person offers.

32. The automated communication system as defined in claim 31, wherein the requested inventory is given in the form selected from the group consisting of: a description of a good: a description of a service, a category of a good, a category of a service, a Stock Keeping Unit (SKU), a Universal Product Code (UPC), a International Standard Book Number, a description of a manufacturer, a description of the function of a good, a description of a function of a service, and a combination thereof.

33. The automated communication system as defined in claim 31, wherein the in-person offer includes a duration for which the in-person offer is irrevocable.

34. The automated communication system as defined in claim 31, the location of the consumer device location and the merchant location are each selected from the group consisting of: the street address of the consumer device, the latitude and longitude of the consumer device, the World Geodetic System coordinates of the consumer device, and combinations thereof.

35. The automated communication system as defined in claim 31, wherein the consumer device is selected from the group consisting of: a cellular phone, a kiosk, and a personal digital assistant.

36. The automated communication system as defined in claim 31, wherein the second distance includes at least one of: the first distance and a relative distance between the consumer device and a competitor of each said merchant in the second plurality thereof.

37. The automated communication system as defined in claim 31, further comprising an offer confirmation code for each said third set of matching merchants, wherein:
the second consumer device transmission to the consumer further includes the offer confirmation code for each said third set of matching merchants;
and
the offer confirmation code for each said third set of matching merchants is further transmitted to the respective each said third set of matching merchants.
